(19) United States
(12) Patent Application Publication
(10) Pub. No.: US 2015/0323904 A1
(43) Pub. Date: Nov. 12, 2015

(54) Method For Communicating Running Clock Status Using Low Bandwidth

(71) Applicant: Bruce Rempe, La Porte City, IA (US)

(72) Inventor: Bruce Rempe, La Porte City, IA (US)

(21) Appl. No.: 14/274,774

(22) Filed: May 12, 2014

(51) Int. Cl. G04F 1/00; G04G 99/00

(52) U.S. Cl. CPC G04F 1/005; G04G 99/006

(57) ABSTRACT

Millions of people play sports around the world. Most sports involve some form of clock that counts down the amount of time remaining in the period or quarter. This clock is typically run through a form of hardware that serves as a scoreboard controller. The present invention relates to a way of communicating the amount of time remaining on the scoreboard to a remote computer system using minimal bandwidth. This is achieved by using a pair of numeric variables and an optional Boolean variable.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not applicable

### INCORPORATION-BY-REFERENCE OF MATERIAL SUBMITTED ON A COMPACT DISC

Not Applicable

### BACKGROUND OF THE INVENTION

1. Field of the Invention

Many children, high school and University students play sports in the United States and around the world. There are also many city, metro and community leagues of youth and adult games and players. Most sports use some form of scoreboard to keep track of the current status of the game being played. To run a scoreboard, there has to be some form of hardware that serves as the scoreboard controller, which allows a person to input the data. The scoreboard controller could also be considered a source computer system. The present invention discloses a method to accurately convey running clock information from the source computer system to a receiving computer system while using minimal bandwidth.

2. Description of Related Art

Prior art exists that addresses transferring data from a scorekeeping device to a remote system. US Pub. 2002/0138163 discloses transmitting statistical data from a scorekeeping device to a central database to display to a user. US Pub. 2012/0256373 discloses a portable scoreboard system that updates the scoreboard based on devices worn by players. Neither discloses a specific protocol for transmitting the amount of time remaining on the clock using a minimal amount of bandwidth.

### BRIEF SUMMARY OF THE INVENTION

The present invention relates to a method for transferring the status of a source clock from a source computer system to a receiving computer system with a minimal use of bandwidth. A source computer system first sends the status of a clock on the source computer system. The source computer system communicates the clock information using a pair of variables and an optional Boolean variable. The receiving computer system will process the data from the source computer system and display the clock status to a user.

### BRIEF DESCRIPTION OF THE SEVERAL VIEWS OF THE DRAWINGS

The invention is a process for conveying the time status of a source clock from a source computer system to a receiving computer system with the steps of the process illustrated in the accompanying drawings, which form a part hereof and wherein:

FIG. 1 is a flowchart depicting the chain of how information is passed from the source computer system to the receiving computer system.

FIG. 2 is a flowchart depicting the chain of how information is passed from the source computer system to the receiving computer system with a description of exactly what information is being passed or processed in each step.

FIG. 3 is a flowchart depicting the chain of how information is passed from the source computer system through an intermediate relay system to the receiving computer system.

FIG. 4 is a flowchart depicting the chain of how information is passed from the source computer system through an intermediate relay system to the receiving computer system with a description of exactly what information is being passed or processed in each step.

### DETAILED DESCRIPTION OF THE INVENTION

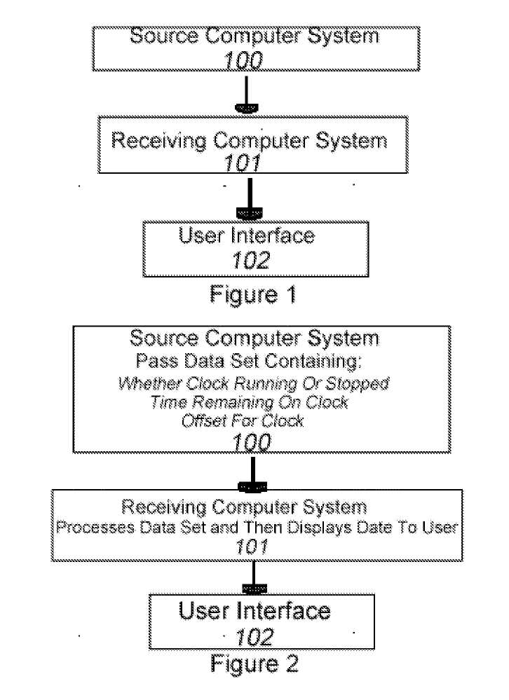

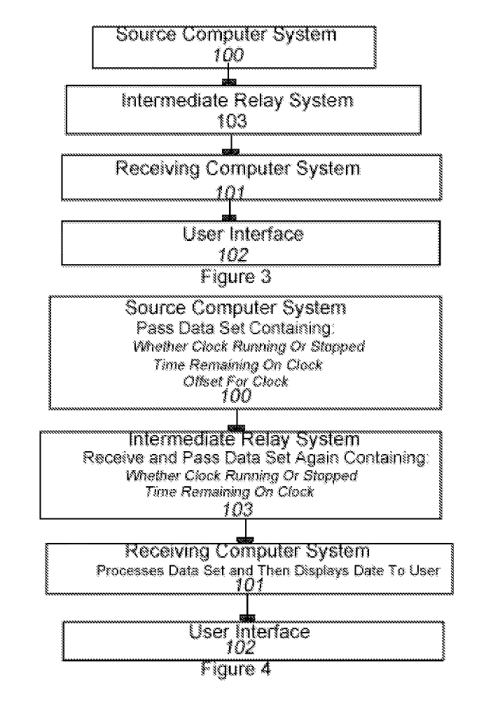

The invention is carried out as illustrated in FIGS. 1-4. The invention is used to communicate the status of a clock that is counting down on a source computer system 100 to a receiving computer system 101 while consuming a relatively low amount of bandwidth. The source computer system 100 sends data to the receiving computer system 101 through a communication protocol. The communication protocol conveys a set of data that includes the amount of time remaining on the clock, whether the clock is running or stopped, and whether any time passed since the data was set.

The communication protocol can convey this set of data using two primary methods. The first primary method is by using two numeric variables and a Boolean variable. The first numeric variable conveys how much time is remaining on the clock. This first numeric variable can be calculated by converting the time remaining on the source computer system to an integer format. For example, if there were three minutes twenty seconds left on the clock, the first numeric variable would be passed as two hundred seconds. The first numeric variable can be expressed in any format that represents time, though the two most common formats will be seconds and milliseconds.

Using the first primary method, the second numeric variable conveys an amount of time elapsed since the first numeric variable was a true representation of how much time was remaining on the clock. For example, the source computer system 100 passes a first numeric variable of four hundred seconds but it is three seconds later that the values are transmitted to the receiving computer system 101. The second numeric variable would then be either three seconds or three thousand milliseconds. Other time units can also be used for the second numeric variable, but again, the most common units will be seconds and milliseconds. This second numeric variable can be used by the receiving computer system 101 to account for this “offset” between when the first numeric variable is set and when it is transmitted and received. The Boolean variable conveys whether the clock is currently running or stopped. Whether the clock is running is critical to the importance of the second numeric variable. That is, if the clock is stopped, it really does not matter how much time has passed since the first numeric variable was an accurate representation, except that the second numeric variable may represent the time passed since the clock was stopped, thereby conveying an accurate history of clock operations.

The receiving computer system 101 processes the communication protocol by correlating the first numeric variable with an internal clock on the receiving computer system 101. For example, the receiving computer system 101 may receive a first numeric variable of five hundred seconds and correlate this to 8:15:23 on its internal clock. When the internal clock reads 8:16:23, the receiving computer system 101 will know that one minute, or sixty seconds, has passed, which would mean that this sixty seconds would be subtracted from the five hundred seconds of the first numeric variable to obtain a current value of four hundred forty seconds remaining. These four hundred forty seconds will be converted into a time format that can be displayed to an end user or remote viewer 102. The most common format would be the minute, second, millisecond (00:00.000) format.

The receiving computer system 101 would also take into account the second numeric variable if it is not zero when making this calculation to determine how much of an adjustment should be made to the final display.

For example, if the receiving computer system 101 receives a first variable of five hundred seconds and correlates this to 1:00:15 on an internal clock, and receives a second variable of zero seconds, the receiving computer system 101 will take this into account. When the receiving computer system's internal clock reaches 1:01:15, with a second numeric variable of zero, the receiving computer system 101 would calculate that sixty seconds has passed and display four hundred forty seconds to the user or remote viewer 102 as 7:20.000. Using these same numbers, but with a second numeric variable of three seconds, the receiving computer system 101 would subtract this three seconds from it's internal clock to establish a “baseline time” of 1:00:12. The receiving computer system then continuously compares its current internal clock value with the established baseline value of 1:00:12 to determine the amount of time passed since the value was established. When the receiving computer system's internal clock reaches 1:01:15, this is compared to the baseline value of 1:00:12 to determine that 63 seconds has passed since the value was set. The receiving computer then subtracts 63 seconds from the original 500 value to determine that 437 seconds remain. The receiving computer system then translates this to display 7:17.000.

The second primary method for the communication protocol to send this data from the source computer system 100 to the receiving computer system 101 is to pass a signed first numeric variable and a second numeric variable and no Boolean variable.

In the second primary method, the receiving computer system 101 converts the first numeric variable to a time remaining exactly the same way as the first primary method. The receiving computer system 101 also uses the second numeric variable in the exact same way as the first primary method. The only difference in the second primary method is that the sign on the first numeric variable is how the receiving computer system will determine whether the clock is currently running. This can be done with no sign, or a positive sign, indicating that the clock is running, and a negative sign indicating that the clock is stopped. The reverse could also be used, where no sign, or a positive sign indicates the clock is stopped and a negative sign indicating the clock is running.

There is an additional variation to how data can be passed from the source computer system 100. Rather than passing the data directly from the source computer system 100 to the receiving computer system 101, the data could first be sent to through an intermediate relay system 103 before being sent to the final receiving computer system 101. This intermediate relay system 103 is comprised of a chain of servers. The chain of servers could either be a single server or however many servers are required. When the intermediate relay system 103 is being used, each server along the chain will receive the data from the previous server or source computer system, and process the data. After the server receives the data, it will act as a de facto source computer system and repeat the communication process to the next server in the chain. Each server will perform this task the same way, until the data reaches a final server that will relay the data to the final receiving computer system 101. After the data reaches the receiving computer system 101, the same conversion to a readable clock will be performed to display the data to an end user 102.

1. A method for transferring a time from a countdown clock over a network while consuming a low amount of bandwidth, comprising:
a source computer system that passes a set of data corresponding to a countdown clock over a network;
wherein said set of data of said source computer system comprises whether said countdown clock is running or stopped;
wherein said set of data indicates an amount of time remaining on said countdown clock;
wherein said set of data indicates an offset amount of time since said time remaining on said countdown clock was accurate to allow a receiving computer system to take into account said offset amount of time;
wherein said network subsequently passes said set of data corresponding to said countdown clock to said receiving computer system;
wherein said receiving computer system subsequently correlates said set of data corresponding to said countdown clock to an internal clock on said receiving computer system;
wherein said receiving computer system monitors an amount of time elapsed on said internal clock and makes a comparison between said amount of time elapsed on said internal clock to said set of data corresponding to said countdown clock;
wherein said receiving computer system calculates an amount of time remaining on said countdown clock based on said comparison of said amount of time elapsed on said internal clock and said set of data corresponding to said countdown clock.

2. The method of claim 1, wherein said source computer system is a scoreboard controller.

3. The method of claim 2, wherein said receiving computer system is a mobile application, desktop application, or a server system.

4. The method of claim 3, wherein said countdown clock of said source computer system is a countdown clock for an athletic event.

5. The method of claim 4, wherein said set of data passed from said source computer system is comprised of a first numeric variable, a second numeric variable and a first Boolean variable.

6. The method of claim 5, wherein said first numeric variable of said set of data is calculated by converting said amount of time remaining on said countdown clock for an athletic event of said scoreboard controller to seconds;
and said second numeric variable is calculated by converting said offset amount of time to seconds.

7. The method of claim 5, wherein said first numeric variable of said set of data is calculated by converting said amount of time remaining on said countdown clock for an athletic event of said scoreboard controller to milliseconds;
and said second numeric variable is calculated by converting said offset amount of time to milliseconds.

8. The method of claim 6, wherein said Boolean variable of said set of data comprises a true value when said countdown clock of said source computer system is running and said Boolean variable of said set of data comprises a false value when said countdown clock of said source computer system is stopped.

9. The method of claim 7, wherein said Boolean variable of said set of data comprises a true value when said countdown clock of said source computer system is running and said Boolean variable of said set of data comprises a false value when said countdown clock of said source computer system is stopped.

10. A method for transferring a time from a countdown clock over a network while consuming a low amount of bandwidth, comprising:
a source computer system that passes a set of data corresponding to a countdown clock over a network;
wherein said set of data of said source computer comprises whether said countdown clock is running or stopped;
wherein said set of data also comprises an amount of time remaining on said countdown clock;
wherein said set of data also comprises an offset amount of time since said time remaining on said countdown clock was accurate;
wherein said network subsequently passes said set of data corresponding to said countdown clock to an intermediate relay system;
wherein said intermediate relay system comprises passing said set of data through a chain of remote servers;
wherein said chain of remote servers can be a single server or multiple servers;
wherein said intermediate relay system receives and processes said set of data;
wherein every server within said intermediate relay system receives said set of data, then subsequently acts identically to said source computer system by updating said set of data and passing said updated set of data to a next server along said chain of remote servers;
wherein when said set of data reaches a final server along said chain of remote servers, said final server performs a final update of said set of data and then passes said set of data to a receiving computer system;
wherein said receiving computer system subsequently correlates said set of data corresponding to said countdown clock to an internal clock on said receiving computer system;
wherein said receiving computer system monitors an amount of time elapsed on said internal clock and makes a comparison between said amount of time elapsed on said internal clock to said set of data corresponding to said countdown clock;
wherein said receiving computer system calculates an amount of time remaining on said countdown clock based on said comparison of said amount of time elapsed on said internal clock and said set of data corresponding to said countdown clock.

11. The method of claim 10, wherein said source computer system is a scoreboard controller.

12. The method of claim 11, wherein said remote computer system is a mobile application, desktop application, or a server system and said receiving computer system is a mobile application, desktop application, or a server system.

13. The method of claim 12, wherein said countdown clock of said source computer system is a countdown clock for an athletic event.

14. The method of claim 13, wherein said set of data passed from said source computer system is comprised of a first numeric variable and a second numeric variable;
wherein said first numeric variable indicates whether said countdown clock is running based on whether said first numeric variable is positive or negative.

15. The method of claim 13, wherein said first numeric variable of said set of data is calculated by converting said amount of time remaining on said clock for an athletic event of said scoreboard controller to seconds;
and said second numeric variable is calculated by converting said offset amount of time to seconds.

16. The method of claim 15, wherein said first numeric variable of said set of data is calculated by converting said amount of time remaining on said clock for an athletic event of said scoreboard controller to milliseconds;
and said second numeric variable is calculated by converting said offset amount of time to milliseconds.

17. The method of claim 15, wherein said first numeric variable of said set of data comprises a positive numeric variable when said countdown clock of said source computer system is running and said first numeric variable of said set of data comprises a negative numeric variable when said countdown clock of said source computer system is stopped.

18. The method of claim 16, wherein said first numeric variable of said set of data comprises a positive numeric variable when said countdown clock of said source computer system is running and said first numeric variable of said set of data comprises a negative numeric variable when said countdown clock of said source computer system is stopped.

19. A method for transferring a time from a countdown clock over a network while consuming a low amount of bandwidth, comprising:
a source computer system that passes a set of data corresponding to a countdown clock over a network;
wherein said set of data of said source computer comprises whether said countdown clock is running or stopped using a first numeric variable;
wherein said set of data indicates an amount of time remaining on said countdown clock using same said first numeric variable;
wherein said set of data indicates an amount of elapsed time since said time remaining on said countdown clock was accurate to allow for an offset to said amount of time remaining on said countdown clock;
wherein said network subsequently passes said set of data corresponding to said countdown clock to a receiving computer system;
wherein said receiving computer system subsequently correlates said set of data corresponding to said countdown clock to an internal clock on said receiving computer system;
wherein said receiving computer system monitors an amount of time elapsed on said internal clock and makes a comparison between said amount of time elapsed on said internal clock to said set of data corresponding to said countdown clock;
wherein said receiving computer system calculates an amount of time remaining on said countdown clock based on said comparison of said amount of time elapsed on said internal clock and said set of data corresponding to said countdown clock.

20. The method of claim 19, wherein said first numeric variable is positive when said countdown clock is running and said first numeric variable is negative when said countdown clock is stopped.
